(19) United States
(12) Patent Application Publication
(10) Pub. No.: US 2015/0106128 A1
(43) Pub. Date: Apr. 16, 2015

(54) SYSTEM AND METHOD TO FACILITATE A COMMUNICATION INTERFACE BETWEEN INSURANCE AGENT AND UNDERWRITER DEVICES

(71) Applicants: Timothy P. Brady, Easton, CT (US); Derrick J. Karle, Wallingford, CT (US); James S. Rogers, Willington, CT (US); Steven Anthony Simone, Helotes, TX (US)

(72) Inventors: Timothy P. Brady, Easton, CT (US); Derrick J. Karle, Wallingford, CT (US); James S. Rogers, Willington, CT (US); Steven Anthony Simone, Helotes, TX (US)

(21) Appl. No.: 14/050,802

(22) Filed: Oct. 10, 2013

(51) Int. Cl. G06Q 40/08

(52) U.S. Cl. CPC G06Q 40/08
USPC 705/4

(57) ABSTRACT

According to some embodiments, an insurance entity may receive information associated with an insurance policy. Based on the received information associated with the insurance policy, supplemental insurance information may be automatically determined. A communication interface, such as a substantially real-time interface for text and/or video communications, may then be facilitated between an insurance agent device and an underwriter device in accordance with the supplemental insurance information.

### BACKGROUND

An insurance agent may exchange information with one or more underwriters associated with insurer for a number of different reasons. For example, an existing or potential consumer may access an insurance agent's web page to determine a yearly or monthly cost of an insurance policy (e.g., hoping to save money or increase a level of protection by selecting a new insurance company). The consumer may provide basic information to the insurance agent (e.g., his or her name, a type of business, date of birth, occupation, etc.), and the insurance agent may use this information to request a premium quote from the insurer. In some cases, the insurer will simply respond to the insurance agent with a premium quote. In other cases, however, an underwriter associated with insurer will ask the insurance agent to provide additional information so that an appropriate premium quote can be generated. For example, an underwriter might ask the insurance agent to indicate whether or not the consumer stores hazardous chemicals at his or her business establishment. Only after such additional information is determined by the insurer can an appropriate risk analysis, underwriting decision, and/or premium pricing process be performed.

Exchanging information between the insurance agent and underwriter, however, can be a time consuming and inefficient process. For example, an insurance agent may typically need to exchange telephone calls with an underwriter, fax documents associated with the consumer, and/or send email messages to the underwriter. Each of these steps may involve a delay in the process, and, as a result, some consumers may abandon their investigation of potential insurance policy options before learning what the premium would be.

It would be desirable to provide systems and methods to facilitate an exchange of information between an insurance agent and an underwriter in an automated, efficient, and accurate manner.

### SUMMARY OF THE INVENTION

According to some embodiments, systems, methods, apparatus, computer program code and means may be provided to facilitate an exchange of information between an insurance agent and an underwriter an automated, efficient, and accurate manner. In some embodiments, an insurance entity may receive information associated with an insurance policy. Based on the received information associated with the insurance policy, supplemental insurance information may be automatically determined A communication interface, such as a substantially real-time interface for text and/or video communications, may then be facilitated between an insurance agent device and an underwriter device in accordance with the supplemental insurance information.

A technical effect of some embodiments of the invention is an improved and computerized method of facilitating an exchange of information between an insurance agent and an underwriter. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 illustrates a method of processing a request from an insurance agent in accordance with some embodiments.

FIGS. 4 through 7 illustrate examples of displays according to some embodiments.

FIG. 8 illustrates several displays in accordance with some embodiments described herein.

FIG. 9 is an example of an insurance entity platform according to some embodiments.

FIG. 10 is a tabular portion of a communication interface database according to some embodiments.

FIG. 11 is process flow diagram associated with some embodiments of the present invention.

FIG. 12 is a block diagram of a communication routing system in accordance with some embodiments described herein.

FIG. 13 is an illustration of communication routing decisions in accordance with some embodiments.

### DETAILED DESCRIPTION

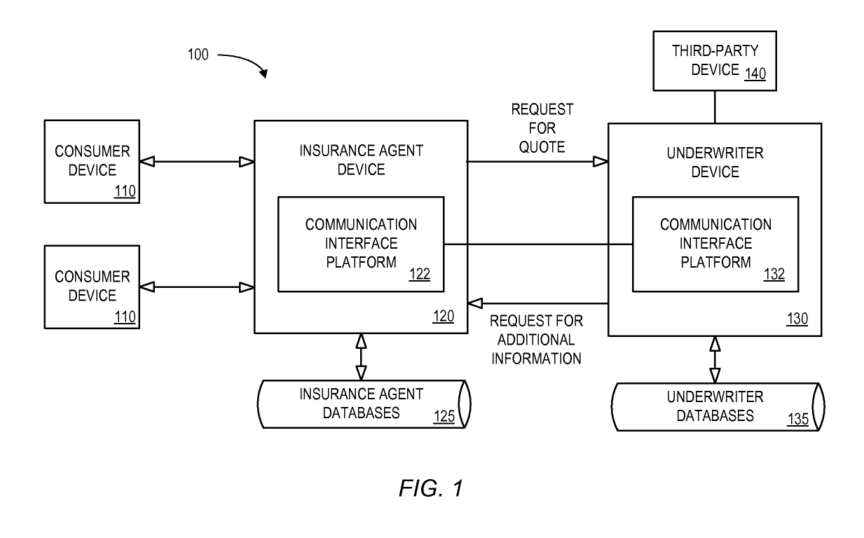

An insurance agent may exchange information with one or more underwriters associated with insurer. For example, an insurance agent may provide the insurer with information about an existing or potential consumer and request an insurance policy premium quote. In some cases, an underwriter associated with insurer will ask the insurance agent to provide additional information so that an appropriate premium quote can be generated. To help facilitate an exchange of information between an insurance agent and an underwriter, FIG. 1 is a block diagram of a system 100 according to some embodiments of the present invention. In particular, an insurance agent device 120 may receive information from remote consumer devices 110. The insurance agent device 120 might be associated with, for example, an insurance agent, an insurance broker, or an entity that provides consumers with quotes from multiple insurance companies. The consumer devices 110 might comprise, for example, Personal Computers (PCs), laptop computers, hand-held computers, wireless devices, smartphones, set-top boxes, and/or kiosks (e.g., at an automobile dealership) that can transmit information to and receive information from the insurance agent device 120. By way of examples, a consumer device 110 might be associated with a consumer's home computer, vehicle computer, or smartphone executing a browser that exchanges information with a web server associated with the insurance agent device 120. Based on information received from consumers, the insurance agent device 120 may transmit a request for an insurance premium quote to an underwriter device 130.

According to some embodiments, an “automated” insurance agent device 120 and/or an underwriter device 130 may facilitate an exchange of information. As used herein, the term “automated” may refer to, for example, actions that can be performed with little or no human intervention. By way of example only, the insurance agent device 120 and/or underwriter device 130 may execute communication interfaced platforms 122, 132 and may include and/or communicate with a PC, an enterprise server, or a database farm. According to some embodiments, the insurance agent device 120 and/or underwriter device 130 is further associated with a salesforce automation, a Consumer Relationship Management (“CRM”) application, a Customer Service Manager (“CSM”)/content management system such as interwoven, Fatwire, etc. The underwriter device 130 may, according to some embodiments, be associated with an insurer that issues insurance policies to consumers and may include business logic and rules associated with an underwriting process.

As used herein, devices, including those associated with the insurance agent device 120, the underwriter device 130, and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The insurance agent device 120 may access information in one or more local insurance agent databases 125, and the underwriter device may access information in one or more underwriter databases 135. The databases 125, 135 may include, for example, policy holder information, consumer data, and/or underwriting weighting factors and/or formulas. As will be described further below, the local databases 125, 135 may be used to help determine supplemental insurance information to facilitate communications.

Although a single insurance agent device 120 and a single underwriter device 130 are shown in FIG. 1, any number of such devices may be included. Moreover, various devices described herein might be combined according to embodiments of the present invention. For example, in some embodiments, the insurance agent device 120 and insurance agent database 125 might be co-located and/or may comprise a single apparatus.

According to some embodiments, the underwriter device 130 may also exchange information with a remote third-party device 140. The remote third-party device 140 might, for example, be associated with a credit agency, a governmental Department of Motor Vehicle (DMV) server, etc.

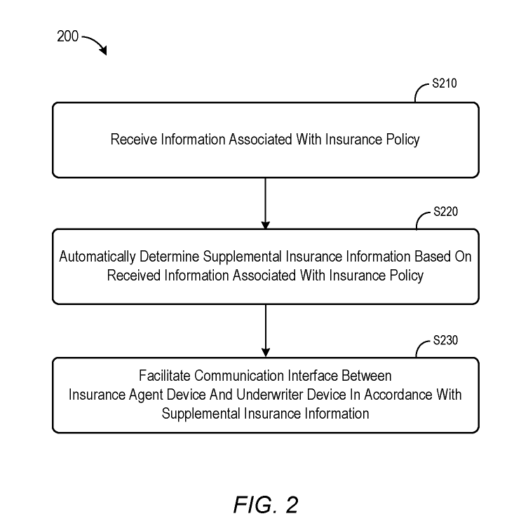

FIG. 2 illustrates a method that might be performed, for example, by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, information associated with an insurance policy may be received by an “insurance entity.” As used herein, the phrase insurance entity may refer to, for example, an insurance agent or an underwriter associated with an insurer. Moreover, note that the insurance policy may be associated with an existing insurance policy, an insurance policy renewal, and/or a potential insurance policy (e.g., an insurance policy that may be issued to a consumer in the future). By way of example, the information received at S210 might include a consumer's name or insurance policy number.

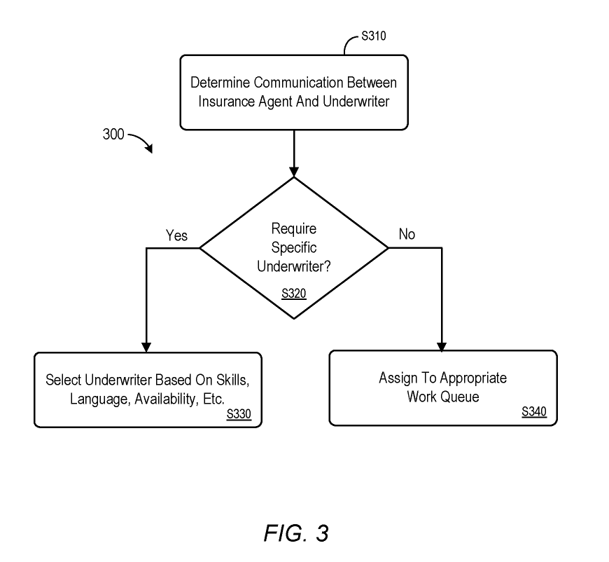

At S220, supplemental insurance information may be automatically determined based on the received information associated with the insurance policy. For example, the supplemental insurance information might include a name, an address, a ZIP code, at least a portion of a Social Security number, a date of birth, demographic information, contact information, an insurance policy number, and/or a business type. For example, an insurance agent device or an underwriter device might look up the supplemental information in a locally stored database. In the case of an automobile insurance policy, the supplemental information might include a Vehicle Identification Number (“VIN”), a number of vehicles, violation information, accident information, loss information, and/or information about other drivers associated with the potential consumer. In some cases, the supplemental information may be received from a third party device, as might be the case with credit score information, income information, governmental department of motor vehicles data, data aggregator information, and/or municipal record data. Other examples of supplemental information include a Standard Industrial Classification (“SIC”) code, a location of business operations, business revenue information, business payroll information, a construction type, and a business square footage. At S230, a communication interface between an insurance agent device and an underwriter device may be facilitated in accordance with the supplemental insurance information. For example, the communication interface might comprise a substantially real-time interface associated text communications (a “chat” interface), video communications, audio communications, and/or screen sharing desktop views. The supplemental information may, for example, be automatically displayed in connection with the communication interface. In some cases, communications between the insurance agent device and the underwriter device are automatically stored in a database (e.g., instant messages and exchanged documents may be automatically archived for quality control and/or to resolve disputes that may arise in the future). In some embodiments, an entire audio and video conversation might be automatically recorded and stored for later replay and review (e.g., to provide regulatory compliance and meet internal requirements). Moreover, reports and searches may be performed in connection with the information that was stored about the customer, agent, and/or underwriter communications. For example, a report listing average resolution times, outcomes, etc. might be generated for a manager. Similarly, all communications containing the word “chemical” might be found via a search query. Note that the communication interface may be facilitated for multiple insurance agent device types and underwriter device types (e.g., various smartphone and/or PC operating systems).According to some embodiments, the supplemental insurance information determined at S220 may comprise a workflow queue identifier or an underwriter party identifier. For example, FIG. 3 illustrates a method of processing a communication request from an insurance agent received at S310 in accordance with some embodiments. If it is determined at S320 that the request needs to be assigned to a specific underwriter, the underwriter may be selected at S330. For example, an underwriter party identifier (e.g., name or telephone number) may be automatically selected based on a skill associated with the underwriter party identifier (e.g., a particular underwriter may specialize in handling certain types of insurance policies), a location associated with the underwriter party identifier (e.g., an underwriter from the insurer's California office may need to be selected), and/or an availability associated with the underwriter party identifier (e.g., when one underwriter is on vacation another underwriter might be selected instead). If it is determined at S320 that the request does not need to be assigned to a specific underwriter, communication request may be assigned to a work queue at S340.

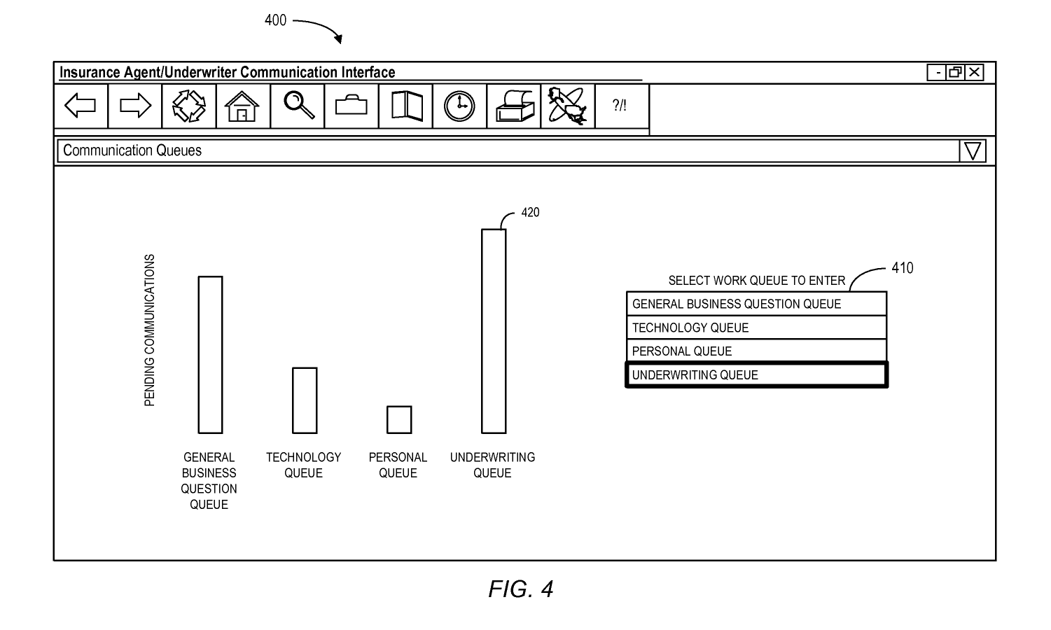

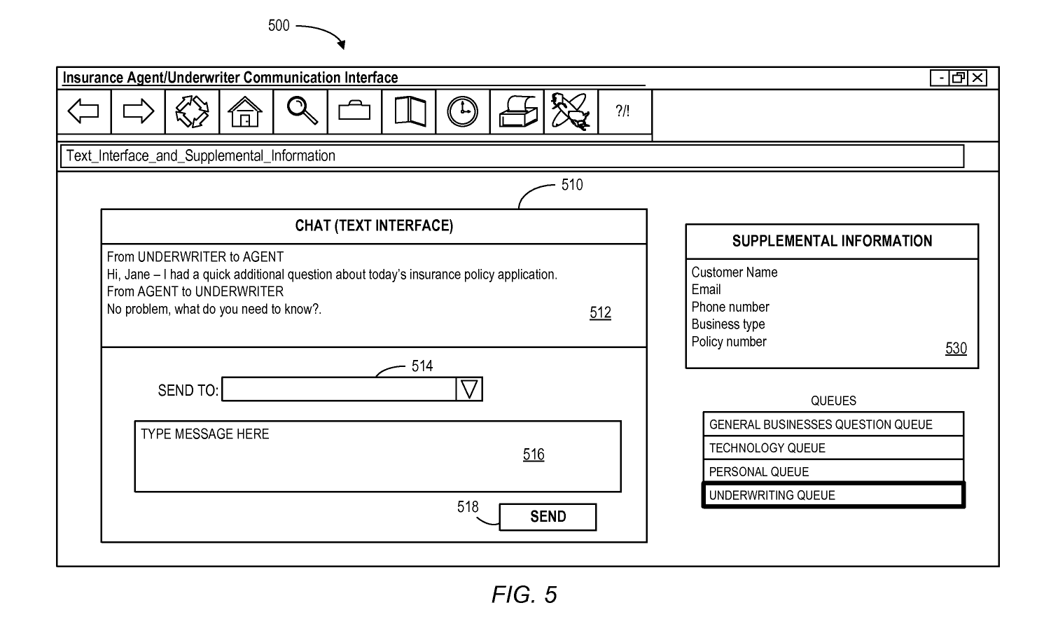

For example, FIG. 4 illustrates a display 400 that might be provided via an underwriter device according to some embodiments. The display 400 includes indications of a number of different work queues 410 (and each may be associated with a different type of communication from an insurance agent). The underwriter might then select one of the queues to initiate communication with the next outstanding insurance agent request in that queue. According to some embodiments, the display 400 further includes information about currently pending communications 420 in each queue. The information about currently pending communications 420 may, for example, help the underwriter select the queue that currently has the longest wait times (e.g., to better serve the insurance agent and/or a potential customer). FIG. 5 illustrates a display 500 that might be provided when the “underwriting queue” has been selected. The display 500 includes a chat or text communication interface area 510 that displays messages 512 between an insurance agent and an underwriter. The text communication interface area 510 further allows selection 510 of a party to receive a new message, a message entry area 516, and a “send” icon 518 to transmit the entered message to the selected party. Note that the display further includes supplemental information 530 that has been automatically determined by the system (e.g., a policy number and business type associated with a request for an insurance premium quote). The display 500 may be presented to an insurance agent and/or an underwriter, for example, when a “click to chat” link or icon is selected. According to some embodiments, a communication link with an appropriate, available underwriter (e.g., having a specialized expertise) may be automatically selected for the insurance agent. As a result, quicker resolutions and increased insurance policy business may be achieved.

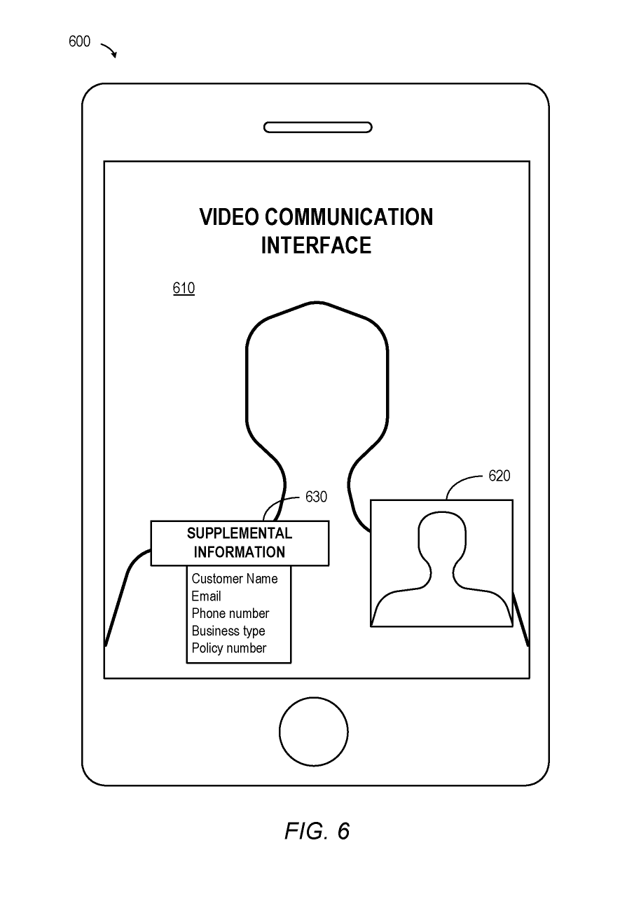

In additional to text messages, some embodiments may provide for video communications between an insurance agent and an underwriter. For example, FIG. 6 illustrates a display 600 that might be provided via a smartphone according to some embodiments. In particular, the display 600 includes a video area 610 that may display a moving image of an insurance agent (when the display 600 is shown to an underwriter) or an underwriter (when the display 600 is shown to an insurance agent). The display 600 may further include a secondary video area 620 displaying a moving image of the person holding the smartphone and supplemental information 630 that was automatically determined by the system. Note that audio information may also be exchanged via the smartphone and the video areas 610, 620 may be provided instead of, or in addition to, the text interface described with respect to FIG. 5.

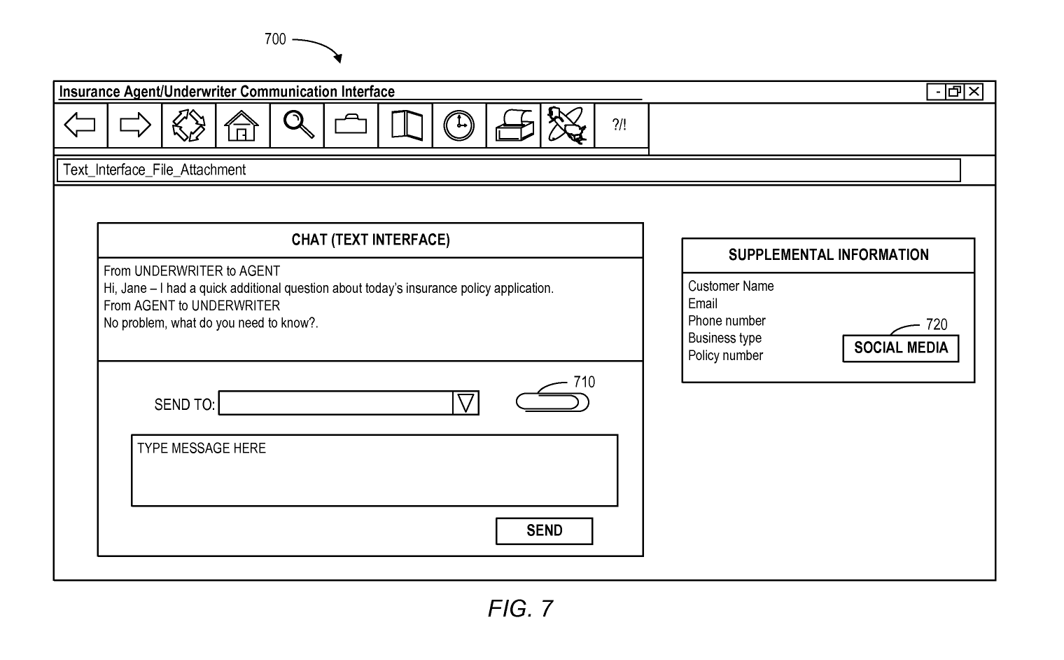

According to some embodiments, file attachments may be exchanged between an insurance agent and an underwriter. For example, FIG. 7 illustrates a display 700 that might be provided to an insurance agent and/or an underwriter according to some embodiments. The display 700 includes an attachment icon 710 that may be selected to attach a word processing, spreadsheet, and/or image attachment to be provided to an insurance agent or underwriter. According to some embodiments, a social media icon 720 may be selected to retrieve information from (or transmit information to) a social media web site such as Facebook, Twitter, LinkedIn, Foursquare, tumblr, YouTube, flickr, digg, upcoming, mybloglog, slideshare, MySpace, and/or a third party service associated with a plurality of social networks. Note that the seamless text messaging, audio (e.g., PSTN or VoIP audio), video, and/or document sharing capabilities of the display 700 may be especially useful in connection with insurance workflows, where high volume and relatively complex issues may be regularly encountered.

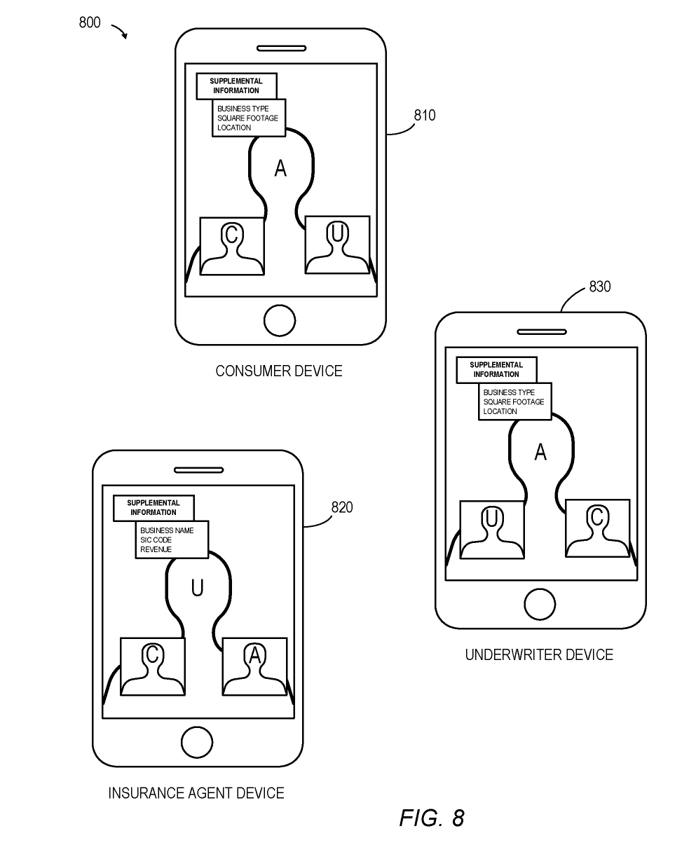

In addition to facilitating communications between an insurance agent and an underwriter, according to some embodiment a consumer may be included in the conversation. For example, FIG. 8 illustrates a system 800 wherein a consumer device 810, an insurance agent device 820, and an underwriter device 830 may all be used to facilitate communications. In particular, the consumer device 810 might mainly display a video of the insurance agent (“A”) along with box-insert videos of the insurance underwriter (“U”) and the potential consumer. Similarly, the insurance agent device 820 might mainly display a video of the underwriter along with box-insert videos of the potential consumer and the insurance agent. The underwriter device might 830, for example, mainly display a video of the insurance agent along with box-insert videos of the potential consumer and the underwriter. In this way, information may be exchanged and an appropriate premium may be determined and provided to the consumer in an automated and efficient manner. Moreover, a high quality personal connection with the consumer may be established by the experience which can be particular helpful with respect to insurance transactions.

Although some embodiments have described insurance agent and underwriter interactions for a new insurance customer, note that any other insurance interactions may be facilitated in accordance with the present invention. For example, agents and underwriters may interact in connection with a policy renewal. Moreover, an underwriter might simultaneously train several insurance agents about a new class, class change, or endorsement associated with an insurer (or train a single new agent that has been recently hired). As other examples, an insurance agent, underwriter, and underwriting manager might discuss the necessity of an escalation. As another example, an underwriting manager might communicate with a loss control specialist (e.g., and as part of the communication link, photographs associated with a work site might be transmitted to the loss control specialist).

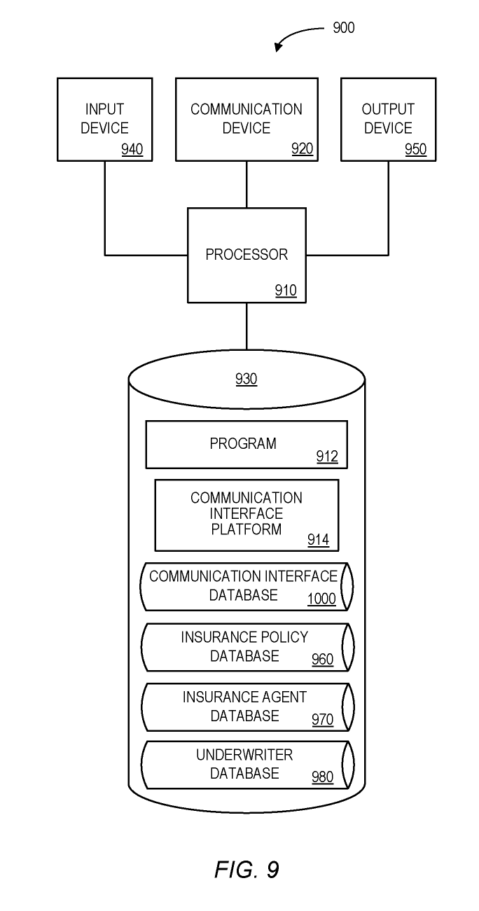

The embodiments described herein may be implemented using any number of different hardware configurations. For example, FIG. 9 illustrates an insurance entity platform 900 that may be, for example, associated with the insurance agent device 120 or underwriter device 130 in the system 100 of FIG. 1. The insurance entity platform 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more remote consumer devices, insurance agent devices, underwriter devices, and/or third-party data services. The insurance entity platform 900 further includes an input device 940 (e.g., a mouse, video camera, and/or keyboard to enter messages) and an output device 950 (e.g., a computer monitor to display messages and/or video information).

The processor 910 also communicates with a storage device 930. The storage device 930 may comprise any appropriate information storage device, including combinations of magnetic storage devices (e.g., a hard disk drive), optical storage devices, mobile telephones, vehicle computers, and/or semiconductor memory devices. The storage device 930 stores a program 912 and/or communication interface platform 914 for controlling the processor 910. The processor 910 performs instructions of the programs 912, 914, and thereby operates in accordance with any of the embodiments described herein. For example, the processor 910 may receive information associated with an insurance policy. Based on the received information associated with the insurance policy, the processor 910 may automatically determine supplemental insurance information. A communication interface, such as a substantially real-time interface for text and/or video communications, may then be facilitated by the processor 910 between an insurance agent device and an underwriter device in accordance with the supplemental insurance information.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the insurance entity platform 900 from another device; or (ii) a software application or module within the insurance entity platform 900 from another software application, module, or any other source.

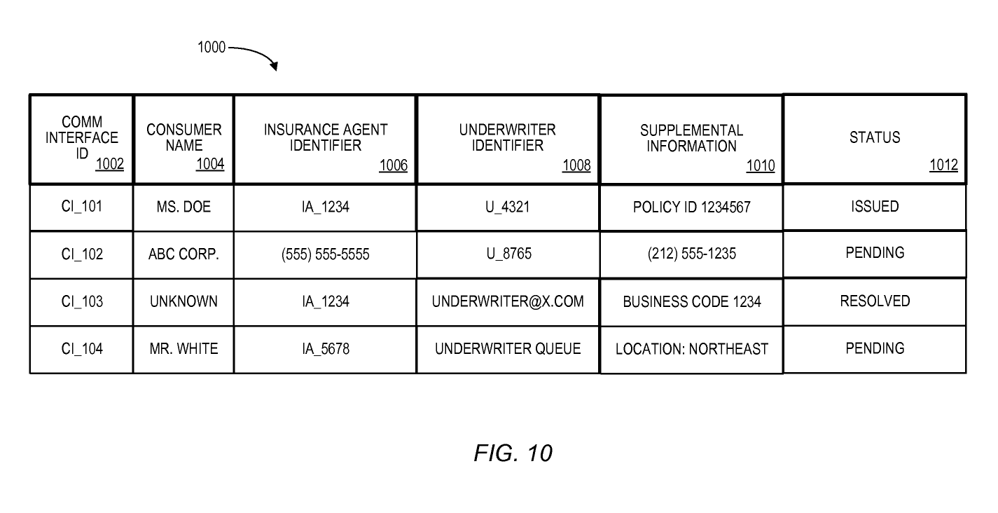

In some embodiments (such as shown in FIG. 9), the storage device 930 stores a communication interface database 1000 (described with respect to FIG. 10), an insurance policy database 960 (e.g., storing information about existing insurance policies), an insurance agent database 970 (e.g., listing names and contact information for a number of consumers), and/or an underwriter database 980 (e.g., storing information about insurance premium quotes).

One example of a communication interface database 1000 that might be used in connection with the insurance entity platform 900 will now be described in detail with respect to FIG. 10. Note that the database described herein is only an example, and additional and/or different information may be stored therein. Moreover, various databases might be split or combined in accordance with any of the embodiments described herein.

FIG. 10 is a tabular portion of a communication interface database 1000 according to some embodiments. The table may include, for example, entries identifying communication links established between insurance agents and underwriters. The table may also define fields 1002, 1004, 1006, 1008, 1010, 1012 for each of the entries. The fields 1002, 1004, 1006, 1008, 1010, 1012 may, according to some embodiments, specify: a communication interface identifier 1002, a consumer name 1004, an insurance agent identifier 1006, an underwriter identifier 1008, supplemental information 1010, and a status 1012. The information in the communication interface database 1000 may be created and updated, for example, whenever a communication link is established between an insurance agent and an underwriter.

The communication interface identifier 1002 may be, for example, a unique alphanumeric code identifying a particular chat or video link established in connection with the consumer name 1004. In particular, the chat or video link is established between the insurance agent identifier 1006 and the underwriter 1008 (which may have been, according to some embodiments, automatically selected based on skills, language, location, availability, etc.). The supplemental information 1010 about the consumer name 1004 may be used to facilitate the insurance premium quote process. The status 1012 might indicate, for example, that the communication link is associated with an insurance policy that has issued (or is pending) and/or a task or request that that has been resolved (or is pending).

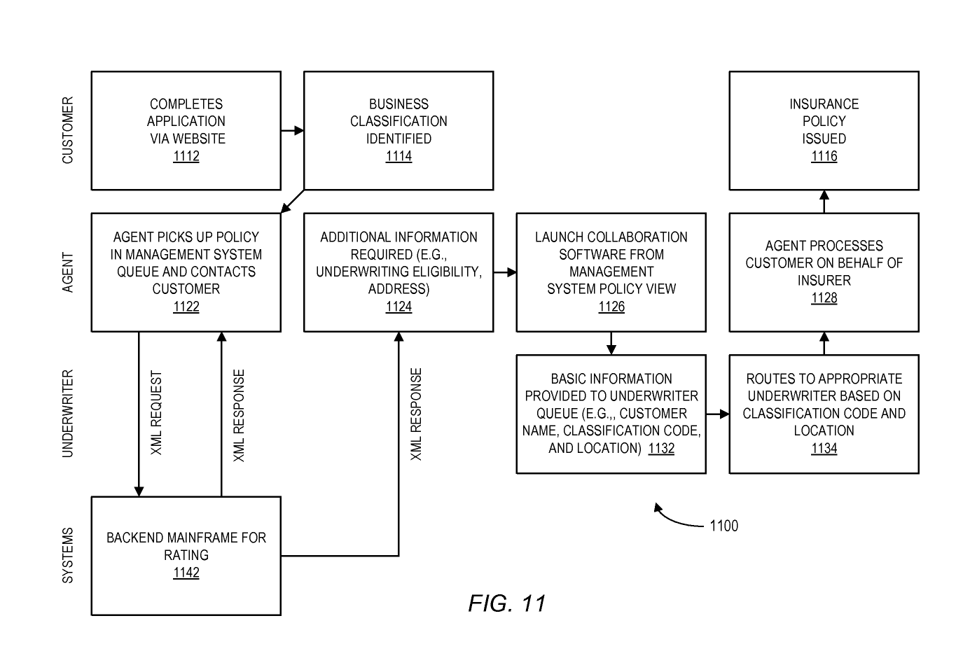

FIG. 11 is process flow diagram 1100 associated with some embodiments of the present invention. Initially, a customer (such as business customer) may complete an insurance application via a web site 1112 and identify a type of business classification 1114 (e.g., retail or construction) and, in some cases, a location associated with the customer. This information may be picked up by an insurance agent in a management system who may contact the customer 1122. Moreover, an XML request may be transmitted to a backend mainframe for rating 1142. In response to the request, the backend mainframe may transmit an XML response to the agent. In some cases, it may be determined that additional information is required 1124 (e.g., underwriting eligibility may need to be determined or the customer might have forgotten to provide a business address).

When it is determined that additional information is required, the agent may launch collaboration software from a management system policy view 1126. Basic information may then be automatically provided to the appropriate underwriter queue 1132 (e.g., the customer name, business classification, and location). For example, based on received information associated with the insurance policy, the system may automatically determine basic supplemental insurance information. The system may then automatically determine an appropriate routing classification associated with the insurance policy (e.g., to select an appropriate underwriter queue) and facilitate a video communication interface between an insurance agent device and an underwriter device in accordance with the routing classification. For example, the system might route the communication to an appropriate underwriter based on the business classification code and location 1134. Note that, the system may also automatically display the supplemental insurance information via the video communication interface. According to some embodiments, an underwriter device may be automatically selected in accordance with at least one work queue length and/or a customer flag associated with the insurance policy (e.g., a flag indicating that the customer is particularly important to the insurer).

The underwriter and insurance agent may then exchange information and the agent may process the customer on behalf of the insurer 1128 and, eventually, an insurance policy may be issued 1116 to the customer (e.g., after a new premium rate is quoted to the customer and the policy is bound).

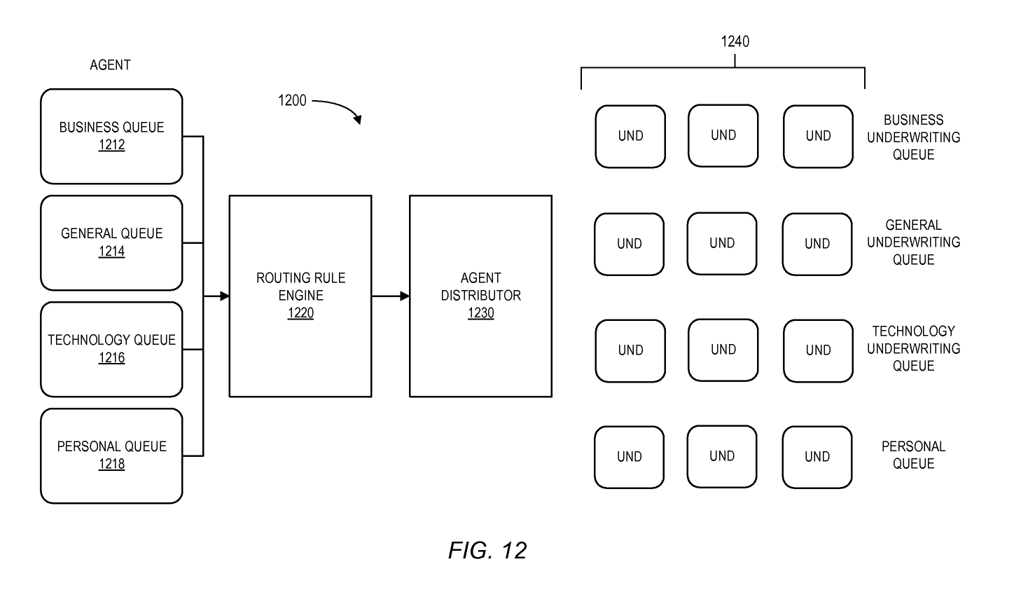

Note that the system may route communications in a number of different ways. For example, FIG. 12 is a block diagram of a communication routing system 1200 in accordance with some embodiments described herein. In this case, an agent might indicate that a particular communication link will be associated with a business queue 1212, a general queue 1214, a technology queue 1216, or a personal queue 1218 (e.g., to let an insurance agent access a particular customer service representative or underwriter). A routing rule engine 1220 and agent distributor 1230 may then interact to select an appropriate queue and/or underwriting agent 1240 to handle the communication. For example, a video link might be automatically established with an underwriting agent 1240 who specializes in insurance for a particular type of business and/or a particular geographic area.

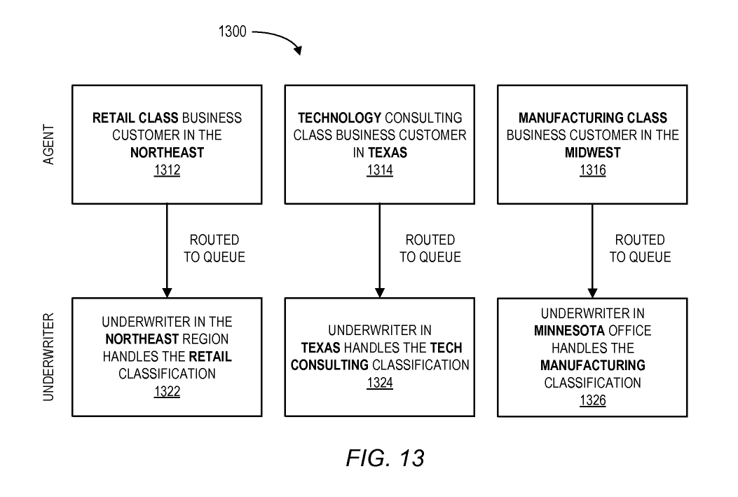

FIG. 13 is an illustration of communication routing decisions 1300 in accordance with some embodiments. In particular, an agent handling a retail class business customer in the northeast 1312 may be routed to a queue for underwriters in the northeast region who handle insurance for businesses classified as “retail” 1322. As another example, underwriters in Texas who handle technology consulting customers 1324 might be selected for an agent dealing with a technology consulting class business customer in Texas 1314. As still another example, an agent working with a manufacturing class business customer in the Midwest 1316 might be routed to an underwriter queue in a Minnesota insurance office that handles matters classified as “manufacturing” 1326. The routing decisions 1300 might be made, for example, by software, hard-coded scripts, adaptive predictive models (e.g., based on historical information), business rules, algorithms, etc.

Thus, embodiments may facilitate communications between an insurance agent and an underwriter in an efficient and accurate manner. As a result, consumers may receive accurate premium quotes in an efficient manner.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with insurance premium quotes. Note, however, that other types of insurance information may also be associated with embodiments described herein. For example, embodiments of the present invention may be used in connection with insurance claims handlers and/or handling processes, workers' compensation claims, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system associated with an insurance agent or underwriter, comprising:
a communication device to receive information associated with an insurance policy;
a computer processor for executing program instructions; and
a memory, coupled to the computer processor, for storing program instructions for execution by the computer processor to:
based on the received information associated with the insurance policy, automatically determining supplemental insurance information;
automatically determining a routing classification associated with the insurance policy;
facilitating a video communication interface between an insurance agent device and an underwriter device in accordance with the routing classification; and
automatically displaying the supplemental insurance information via the video communication interface.

2. The system of claim 1, wherein the underwriter device is automatically selected in accordance with at least one work queue length and a customer flag associated with the insurance policy.

3. The system of claim 1, wherein the insurance policy comprises one of: (i) an existing insurance policy, (ii) an insurance policy renewal, and (iii) a potential insurance policy.

4. The system of claim 1, wherein the supplemental insurance information comprises at least one of: (i) a name, (ii) an address, (iii) a ZIP code, (iv) at least a portion of a Social Security number, (v) a date of birth, (vi) demographic information, (vii) contact information, (viii) an insurance policy number, (ix) a business type, (x) a Vehicle Identification Number, (xi) a number of vehicles, (xii) violation information, (xiii) accident information, (xiv) loss information, (xv) information about other drivers associated with the potential consumer, (xvi) credit score information, (xvii) income information, (xviii) third party data, (xix) governmental department of motor vehicles data, (xx) data aggregator information, (xxi) municipal record data, (xxii) a Standard Industrial Classification code, (xxiii) a location of business operations, (xxiv) business revenue information, (xxv) business payroll information, (xxvi) a construction type, and (xxvii) a business square footage.

5. The system of claim 1, wherein the supplemental insurance information comprises a workflow queue identifier.

6. The system of claim 1, wherein the supplemental insurance information comprises an underwriter party identifier.

7. The system of claim 6, wherein the underwriter party identifier is automatically selected based on at least one of: (i) a skill associated with the underwriter party identifier, (ii) a location associated with the underwriter party identifier, and (iii) an availability associated with the underwriter party identifier.

8. The system of claim 1, wherein the video communication interface is a substantially real-time interface and further comprises at least one of: (i) text communications, (ii) audio communications, (iii) file attachments, and (iv) a screen sharing desktop view.

9. The system of claim 1, wherein at least one of the insurance agent device and the underwriter device comprises: (i) a personal computer, (ii) a workstation, (iii) a mobile computer, (iv) a table computer, or (v) a smartphone.

10. The system of claim 1, wherein communications between the insurance agent device and the underwriter device are automatically stored in a database.

11. The system of claim 1, wherein an additional communication interface with a consumer associated with the insurance policy is facilitated.

12. The system of claim 1, wherein the communication interface is facilitated for multiple insurance agent device types and underwriter device types.

13. The system of claim 1, wherein the communication interface may interact with at least one of: (i) Facebook, (ii) Twitter, (iii) LinkedIn, (iv) Foursquare, (v) tumblr, (vi) YouTube, (vii) flickr, (viii) digg, (ix) upcoming, (x) mybloglog, (xi) slideshare, (xii) MySpace, and (xiii) a third party service associated with a plurality of social networks.

14. A computerized method associated with an insurance entity, comprising:
receiving, by a computer processor of an insurance entity communication platform, information associated with an insurance policy;
automatically determining, by the computer processor of the insurance entity communication platform, supplemental insurance information based on the received information associated with the insurance policy; and
facilitating, by the computer processor of the insurance entity platform, a communication interface between an insurance agent device and an underwriter device in accordance with the supplemental insurance information.

15. The method of claim 14, wherein the insurance policy comprises one of: (i) an existing insurance policy, (ii) an insurance policy renewal, and (iii) a potential insurance policy.

16. The method of claim 14, wherein the supplemental insurance information comprises one of a workflow queue identifier and an underwriter party identifier.

17. A non-transitory, computer-readable medium storing instructions adapted to be executed by a computer processor to perform a method associated with an insurance entity, said method comprising:
receiving information associated with an insurance policy;
automatically selecting, by a computer processor of an insurance entity communication platform, a workflow queue identifier based on the received information associated with the insurance policy; and
facilitating, by the computer processor of the insurance entity platform, a communication interface between an insurance agent device and an underwriter device in accordance with the workflow queue identifier.

18. The medium of claim 17, wherein the workflow queue identifier is automatically selected based at least in part on: (i) an insurance type, (ii) an insurance agent identifier, (iii) a business type code, (iv) a consumer identifier, (v) an insurance policy number, and (vi) a queue length.

19. The medium of claim 18, wherein the insurance policy comprises one of: (i) an existing insurance policy, (ii) an insurance policy renewal, and (iii) a potential insurance policy.

20. The medium of claim 19, wherein the communication interface is associated with all of: (i) a substantially real-time text communication interface, (ii) a video communication interface, (iii) an audio communication interface, and (iv) a file attachment interface.
